(19) United States
(12) Patent Application Publication
(10) Pub. No.: US 2012/0296612 A1
(43) Pub. Date: Nov. 22, 2012

(54) COMPUTER-IMPLEMENTED METHOD FOR DIGITALLY SHORTENING OF A CAP OF A DENTAL BRIDGE AND A COMPUTER-READABLE MEDIUM

(75) Inventors: Kristian Heinz, Berlin (DE); Felix Berlin, Grafelfing (DE)

(73) Assignee: Straumann Holding AG, Basel (CH)

(21) Appl. No.: 13/474,941

(22) Filed: May 18, 2012

(30) Foreign Application Priority Data
May 20, 2011 (EP) 11 004 199.3

(51) Int. Cl. G06F 17/50

(52) U.S. Cl. 703/1

(57) ABSTRACT

Computer-implemented method for digitally shortening a cap of a dental bridge comprising steps of (a) loading 3D data of the bridge from a computer-readable storage medium or generating 3D data of the bridge with a modelling software, the 3D data comprising cap data and bar data; (b) determining intersection points of a bar with geometrical features of the cap; and in case that a further bar is attached to the cap, repeating step (b); (c) determining from said intersection points an intersection point with the biggest z value; (d) performing a cut of the cap along a cutting surface, the location of which is based on said intersection point with the biggest z value; (e) defining data of a portion of the cap below the cutting surface as shortened cap. Further disclosed is a computer-readable medium for performing the method steps.

### FIELD OF THE INVENTION

The invention relates to a computer-implemented method for digitally shortening of a cap of a dental bridge and a computer-readable medium.

### BACKGROUND

From prior art it is known that a cap that may be attached to a tooth stump or to an implant may be physically shortened. The patent application U.S. Pat. No. 4,253,829 discloses that a blank in shape of a hollow conical body is servable along any one of a plurality of planes normal to the axis of the blank to produce a core form for any particular tooth size.

### SUMMARY OF THE INVENTION

It is the object of the present invention to enable digitally shortening of a cap of a dental bridge to prepare a fitting dental bridge with which a patient may be provided in a comfortable manner.

This object is achieved with a computer-implemented method and with a computer-readable medium. All the method steps described in the following may be performed automatically and do not necessarily need the interaction of a user.

A computer-implemented method for digitally shortening a cap of a dental bridge comprises the step (a) of loading three dimensional data of the dental bridge from a computer-readable storage medium, the three dimensional data comprising cap data describing a cap of the dental bridge and bar data describing at least one bar of the dental bridge, the at least one bar being attached to the cap, or generating three dimensional data of the dental bridge with a modelling software, the three dimensional data comprising cap data describing a cap of the dental bridge and bar data describing at least one bar of the dental bridge, the at least one bar being attached to the cap; step (b) of determining intersection points of one of the at least one bar with geometrical features of the cap such as the intersection points with a wall of the cap and/or intersection points with a longitudinal axis of the cap, said axis being named z axis and extending in a direction from an inward end to an outward end of the cap; and in case that a further bar is attached to the cap, repeating step (b) and considering in repeated step (b) the further bar instead of the one of the at least one bars; step (c) of determining from said intersection points an intersection point with the biggest z value on said z axis; step (d) of performing a cut of the cap along a cutting surface, the location of which is based on said intersection point with the biggest z value, such as said cutting surface being defined to go through said intersection point with the biggest z value; and step (e) of defining data of a portion of the cap below the cutting surface as shortened cap, wherein below means in direction to the inward end of the cap.

The bar data describing at least one bar of the dental bridge may comprise data of the bar defining its physical dimensions, like e.g. geometry, position relative to the cap, and also may comprise data defining virtual dimensions. The virtual dimensions mean that the physical dental bridge may comprise no physical bar at e.g. a position being described by the virtual dimensions. The virtual dimensions may used to determine the intersection points of the at least one bar with geometrical features of the cap. Such geometrical features of the cap may be provided at a position of the cap where no physical bar may be provided in the dental bridge, i.e. the virtual dimensions of the bar may describe the bar at said position.

For digitally shortening a cap of such a dental bridge it may be necessary to take into account intersection points of the virtual dimensions of the bar with a geometrical feature of the cap. Instead of data defining virtual dimensions (or in addition) for the calculation of the intersection points data interpolating the extension of the bar may be obtained by (linearly) interpolating the dimensions that describe the physical dimensions beyond the end of a bar.

For example, when determining intersection points with one bar and the wall of a cap and with said one bar and a longitudinal axis of said cap results in an intersection point with the biggest z value being located on the longitudinal axis, then this intersection point may used to determine the location of the cutting surface. With this selection of the intersection point, the cap, the bar and the attachment of cap and bar may result in a stable dental bridge. In some cases choosing the cutting surface to be based on the intersection of the bar with the longitudinal axis of the cap results to a portion of the cap surrounding the area where the bar joins with the cap which leads to an increased stability of the bridge at this joint.

The cap may have a conical shape with an inward end and an outward end. The inward end of the cap may be attached to a rest tooth or an implant and to the outward end dental fittings may be attached, such as crowns or veneers. If the dental bridge, for example, is attached to the lower jaw of a patient, the inward end of the cap is directed to the bone of the lower jaw and the outward end is directed away from the bone of the lower jaw. The cross section of the wall of the cap may be circular, elliptical or may have a shape being suitable for a predetermined tooth type to which the cap should be attached.

Further, the cap may be provided with a boring extending from the inward end to the outward end such that e.g. a screw may be inserted such that the cap may be attached e.g. to an implant. The boring may have a centre axis coinciding with the longitudinal axis of the cap.

The at least one bar being attached to the cap may have a circular, elliptical, U-shaped, or other polygonal cross section, wherein the cross section may be selected such that a dental restoration may be attached to it an easy but also solid way.

The intersection points may be described by three dimensional coordinates, wherein the z axis may also be the z axis of a Cartesian coordinate system. The z value may then be the z coordinate of the point.

The cutting surface may further be defined by being a plane and having a normal vector extending in direction of the longitudinal axis of the cap. The normal vector of the plane may also have some inclination angle with respect to the direction of the longitudinal axis of the cap. By using a cutting surface to shorten the cap, no scaling of the cap to result in a smaller height is required and thus a possible deformation of the cap due to scaling can be prevented. And as the shortening of the cap is performed in the design process of the dental bridge, a subsequent shortening of the produced cap can be prevented.

The longitudinal axis may be selected to be a central and/or symmetry axis of the cap. For example, depending on the tooth type (e.g. molar, premolar or incisor) to which the cap may be attached a longitudinal axis of the cap may be selected. These teeth and thus also the caps may have different shapes.

The cutting edges of the shortened cap may be rounded. The rounding of said edges may prevent the occurrence of high forces at the edges when a dental restoration being attached to the dental bridge is used, e.g. during a chewing process.

In further steps of the computer-implemented method, a height of the cap below the cutting surface may be determined, it may be determined whether said height is less than a minimum height, if so, the location of the cutting surface may be adjusted such that the shortened cap has the minimum height, and if not, the location of the cutting surface may be maintained. By determining whether the cap below the cutting surface has a minimum height, wherein the height may be the extension of the cap along the longitudinal axis, it is possible to prevent a shortening of a cap to such an extent that e.g. a crown may not be attached to the cap in a secure way. The minimum height may 4 mm, 3.5 mm or 3 mm or may have bigger or smaller values, e.g. depending on the tooth type that should be replaced. Defining a minimum height of the shortened cap ensures that even if a bar is attached to the cap at such a position that the shortening would result in a too short (i.e. with a height less than a minimum height) cap, a useable cap may exist, since the adjusted location of the cutting surface ensures that the height is not less than the minimum height.

For adjusting of the location of the cutting surface, for example, the difference value between the height of the cap below the cutting surface and the minimal height may be determined and the cutting surface may be shifted by this difference value along the direction in which the height is determined to increase the height of the cap below the cutting surface.

The cutting surface may be defined as being plane or curved. By having a curved cutting surface it may be possible to have a larger surface on the cap to which e.g. a crown may be attached in comparison to the surface that may result from cutting the cap along a plane cutting surface.

A dental bridge may comprise two, three, four or more caps from which one, two, three or more caps may be shortened. In case two or more teeth of a patient have to be provided with dental restorations, a dental bridge may be provided which has two or more caps. To these caps one or more bars may be attached and the computer-implemented method may be used to digitally shorten these caps.

Further, the present invention is related to a computer-readable medium having stored thereon instructions, which when executed by a processor, are adapted to perform any of the above identified method steps.

### BRIEF DESCRIPTION OF THE DRAWINGS

Preferred embodiments of the invention will be illustrated with reference to the enclosed figures. In the figures:

FIG. 1 shows a flow diagram describing the computer-implemented method for shortening of a cap of a dental bridge;

FIG. 2a shows a cap with an attached bar;

FIG. 2b shows the cap of FIG. 2a with the performed cut;

FIG. 2c shows the shortened cap of FIGS. 2a and 2b;

FIG. 3a shows a cap with an attached bar;

FIG. 3b shows the cap of FIG. 3a with the performed cut;

FIG. 3c shows the shortened cap of FIGS. 3a and 3b;

FIG. 4a shows a cap with two attached bars; and

FIG. 4b shows a cap with two attached bars.

### DETAILED DESCRIPTION

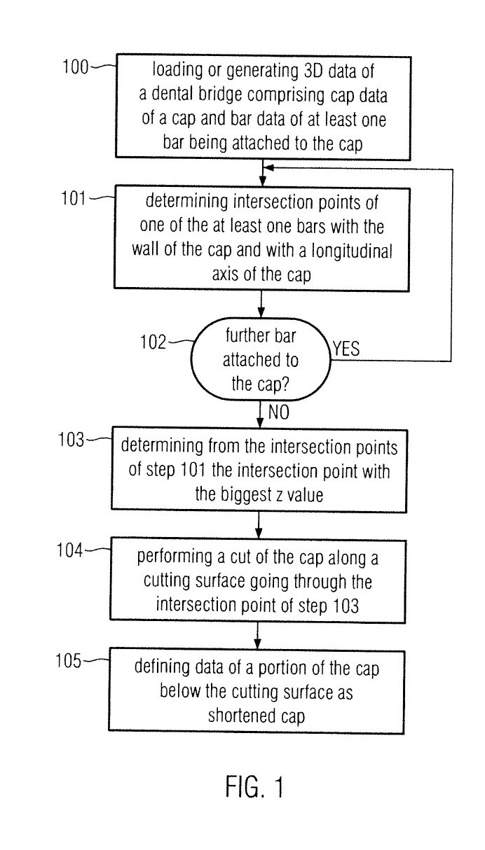

In FIG. 1, a flow diagram with the steps performed in the computer-implemented method is shown. In step 100, three dimensional data of the dental bridge may be loaded from a computer-readable storage medium or the three dimensional data of the dental bridge may be generated with a modelling software, wherein the three dimensional data comprising cap data describing a cap of the dental bridge and bar data describing at least one bar of the dental bridge. The cap data may comprise data of the wall of the cap, the inward and outward end as well as data of a longitudinal axis; further data corresponding to the cap may be comprised by the cap data. The bar data may comprise data of the cross section of the at least one bar and data of the position at and orientation in which it is attached to the cap; further data corresponding to the at least on bar may be comprised by the bar data.

In step 101, intersection points of one of the at least one bars with a wall of the cap and intersection points of said bar with a longitudinal axis of the cap may be determined, wherein the axis is named z axis and extends in a direction from an inward end to an outward end of the cap. The inward end of the cap may be attached to a rest tooth or an implant and to the outward end dental fittings may be attached, such as crowns or veneers. If the dental bridge, for example, is attached to the lower jaw of a patient, the inward end of the cap is directed to the bone of the lower jaw and the outward end is directed away from the bone of the lower jaw.

In step 102, it is determined whether a further bar is attached to the cap, if so (branch “YES”), going back to step 101 and if not (branch “NO”) going to step 103. When a second bar is attached to the cap, its intersection points also have to be taken into account when determining the intersection point with the biggest z value on the z axis of the cap. In most cases the bars may be attached at different heights and with different inclination angles with respect to the z axis of the cap such that the intersection points may be located at different heights.

In step 103, from the intersection points determined in step 101, the intersection point with the biggest z value is determined. With this step from all determined intersection points the one with the biggest z value is selected. Thus, all bars being connected to a cap may be taken into account and it may be prevented that one of several bars may be cut by the cutting surface if it would not have been considered.

In step 104, a cut of the cap along a cutting surface going through said intersection point with the biggest z value is performed. Thus, the existing cap may be separated in two portions, one being the shortened cap and one being some remaining portion of the cap that is not required for the dental bridge.

In step 105, data of a portion of the cap below the cutting surface is defined as shortened cap, wherein below means in direction to the inward end of the cap.

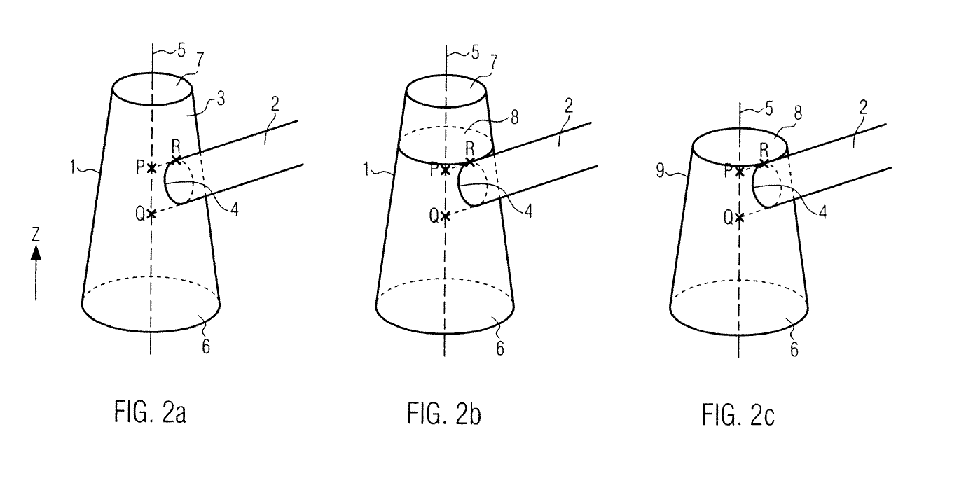

In FIG. 2a, part of a dental bridge with one cap 1 and one bar 2 being attached to the cap 1 is shown. The bar 2 is attached to the cap 1 such that the central axis of the bar 2 is directed towards the inward end 6 of the cap 1.

The intersection points of the surface of the bar 2 with the wall 3 of the cap 1 result in a closed curve 4; in the depicted case, as the bar 2 has a circular cross section, the curve 4 is a deformed ellipse. The intersection of the surface of the bar 2 with the axis 5 of the cap 1 results in two intersections points P, Q.

From these determined intersection points (Le. the intersection points on the closed curve 4 and the two intersection points P, Q on the axis 5), the intersection point R having the biggest z value is determined and then this intersection point R is used to define the cutting surface 8. The intersection point R with the biggest z value lies on the wall 3 of the cap 1. In FIG. 2b, the cutting surface 8 is shown which goes through the intersection point R having the biggest z value. In the depicted case, the cutting surface is plane and its normal vector corresponds to the direction of the axis 5 of the cap 1.

In FIG. 2c, the resulting shortened cap 9 is shown. The new outward end 8 of this cap 9 now corresponds to the cutting surface 8.

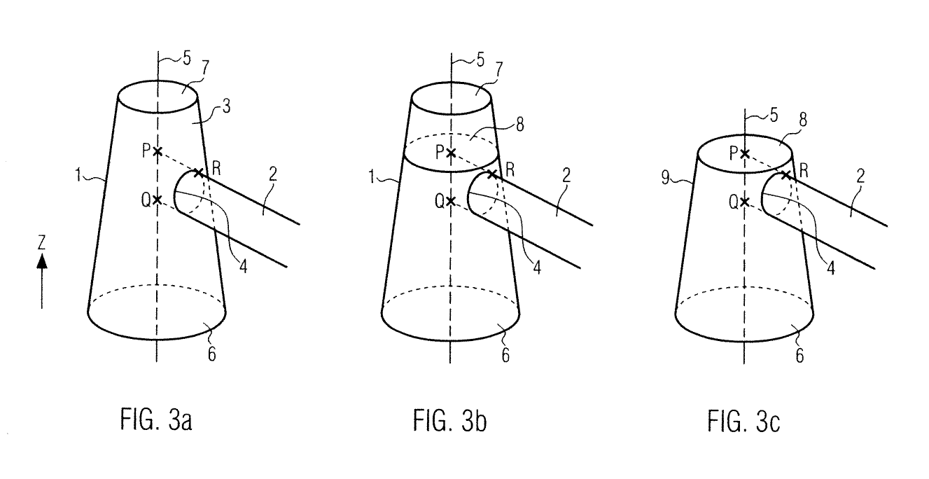

FIG. 3a shows a part of another dental bridge with one cap 1 and one bar 2 being attached to the cap 1. The bar 2 is attached to the cap 1 such that the central axis of the bar 2 is directed towards the outward end 7 of the cap 1.

The intersection points of the surface of the bar 2 with the wall 3 of the cap 1 result in a closed curve 4; in the depicted case, as the bar 2 has a circular cross section, the curve 4 is a deformed ellipse. The intersection of the surface of the bar 2 with the axis 5 of the cap 1 results in two intersections points P, Q.

From these determined intersection points (i.e. the intersection points on the closed curve 4 and the two intersection points P, Q on the axis 5), the intersection point P having the biggest z value is determined and then this intersection point P is used to define the cutting surface 8. The intersection point P with the biggest z value lies on the axis 5 of the cap 1.

In FIG. 3b, the cutting surface 8 is shown which goes through the intersection point P having the biggest z value. In the depicted case, the cutting surface is plane and its normal vector corresponds to the direction of the axis 5 of the cap 1. In FIG. 3c, the resulting shortened cap 9 is shown. The new outward end 8 of this cap 9 now corresponds to the cutting surface 8.

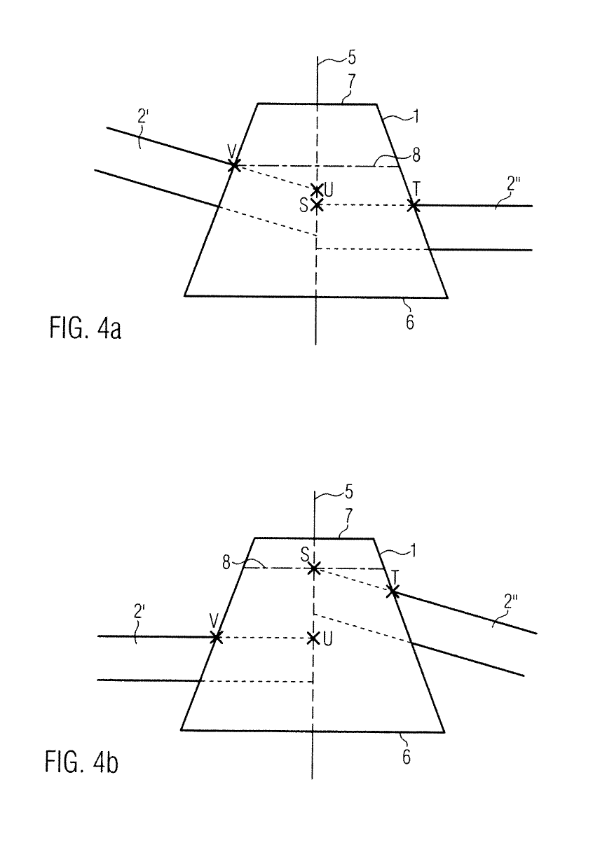

FIG. 4a shows a side view of one example of a cap 1 with two attached bars 2′, 2″. When performing the inventive method, for example, first the intersection points of the bar 2′ on the left-hand-side of the cap 1 with the wall 3 of the cap 1 (point V is indicated as an example) and with the axis 5 of the cap 1 (point U is indicated as an example) may be determined and then the respective intersection points (points T and S are indicated as an example) of the bar 2″ on right-hand-side of the cap 1 may be determined. The intersection point with the biggest z value is the point indicated by V and this intersection point V lies on the wall 3 of the cap 1. The side view of the cutting surface 8 when the normal vector of the cutting surface is directed along the axis 5 of the cap 1 is shown.

In FIG. 4b another configuration of a cap 1 with two bars 2′, 2″ is shown in side view. Here, the intersection point with the biggest z value is the point indicated by S and this intersection point S lies on the axis 5 of the cap 1. The cutting surface 8 thus goes through the intersection point S.

1. Computer-implemented method for digitally shortening a cap of a dental bridge, the method comprising the steps of:
(a) loading three dimensional data of the dental bridge from a computer-readable storage medium, the three dimensional data comprising cap data describing a cap of the dental bridge and bar data describing at least one bar of the dental bridge, the at least one bar being attached to the cap; or
generating three dimensional data of the dental bridge with a modelling software, the three dimensional data comprising cap data describing a cap of the dental bridge and bar data describing at least one bar of the dental bridge, the at least one bar being attached to the cap;
further comprising:
(b) determining intersection points of one of the at least one bars with geometrical features of the cap such as the intersection points with a wall of the cap and/or intersection points with a longitudinal axis of the cap, said axis being named z axis and extending in a direction from an inward end to an outward end of the cap;
and in case that a further bar is attached to the cap, repeating step (b) and considering in repeated step (b) the further bar instead of the one of the at least one bars;
(c) determining from said intersection points an intersection point with the biggest z value on said z axis;
(d) performing a cut of the cap along a cutting surface, the location of which is based on said intersection point with the biggest z value, such as said cutting surface being defined to go through said intersection point with the biggest z value;
(e) defining data of a portion of the cap below the cutting surface as shortened cap, wherein below means in direction to the inward end of the cap.

2. The method of claim 1, further comprising the step of selecting the longitudinal axis to be a central and/or symmetry axis of the cap.

3. The method of claim 1, further comprising the step of rounding of cutting edges of the shortened cap.

4. The method of claim 3, further comprising the step of selecting a rounding radius.

5. The method of claim 1, further comprising the steps of determining a height of the cap below the cutting surface, determining whether said height is less than a minimum height,
if so, adjusting the location of the cutting surface such that the shortened cap has the minimum height,
if not, maintaining the location of the cutting surface.

6. The method of claim 1, further comprising the step of defining the cutting surface as being plane or curved.

7. The method of claim 1, wherein the dental bridge comprises two, three, four or more caps.

8. The method of claim 7, wherein one, two, three, four or more caps are shortened.

9. Computer-readable medium having stored thereon instructions, which when executed by a processor, are adapted to perform any of the method steps of claim 1.
